(19) United States
(12) Patent Application Publication
(10) Pub. No.: US 2012/0300022 A1
(43) Pub. Date: Nov. 29, 2012

(54) SOUND DETECTION APPARATUS AND CONTROL METHOD THEREOF

(75) Inventor: Kazue Kaneko, Kawasaki-shi (JP)

(73) Assignee: CANON KABUSHIKI KAISHA, Tokyo (JP)

(21) Appl. No.: 13/470,586

(22) Filed: May 14, 2012

(30) Foreign Application Priority Data
May 27, 2011 (JP) 2011-119710
Apr. 26, 2012 (JP) 2012-101677

(51) Int. Cl. H04N 7/18; H04N 7/00; G01S 3/80

(52) U.S. Cl. 348/36; 367/118; 348/143; 348/E07.001; 348/E07.085

(57) ABSTRACT

A specific sound is detected from sounds input by a sound input unit, using thresholds for detecting sounds. Images captured by an image capturing unit are recorded. A difference between a recorded image and a current image is calculated, and a location of a moving object is detected from the current image. A correspondence between information indicating a specific position in an image and information indicating sounds that could occur in the specific position is managed. In the case where a moving object is detected, the threshold for detecting a sound is changed, and the specific sound is detected from sounds, using the changed threshold, with reference to the correspondence managed in the position/sound correspondence information management unit.

### BACKGROUND OF THE INVENTION

1. Field of the Invention

The present invention relates to a sound detection apparatus that captures images from an image capturing unit together with inputting sounds from a sound input unit, and detects a specific sound from input sounds using captured images, a control method thereof.

2. Description of the Related Art

Conventionally, there are voice recognition apparatuses that use image information in order to raise the accuracy of voice recognition by reducing the influence of noise and the like. In Japanese Patent Laid-Open No. 59-147398, lip movement is detected, and using the interval during which lip movement is detected as a voice interval, voice recognition is performed during that period. In Japanese Patent No. 03798530, the products of the similarities and probabilities of corresponding syllable candidates are calculated by performing image recognition of lip patterns, and added to the products of the similarities and probabilities of the syllable candidates derived through voice recognition to derive the most probable syllable candidate.

There are also image capturing apparatuses used in video surveillance that determine anomalies using the volume and type of sound.

In the case of determining the type of sound and detecting anomalies in video surveillance or the like, accuracy of the detection becomes an issue. Generally, the number of false negatives increases when trying to reduce false detection, and false detection increase when trying to perform detection without any false negatives.

Even when image information is used in order to reduce false detection, the surveillance target is a place where there could be a plurality of objects, and thus there needs to be a correspondence other than that between syllables and lip shapes, such as a correspondence between position information of objects and types of sounds related thereto, for example.

### SUMMARY OF THE INVENTION

The present invention provides a sound detection apparatus that accurately detects sounds, a control method thereof.

A sound detection apparatus according to the present invention for achieving the above object is provided with the following configuration. That is, a sound detection apparatus that captures images from an image capturing unit together with inputting sounds from a sound input unit, and detects a specific sound from input sounds using captured images, includes a sound detection unit that detects a specific sound from sounds input by the sound input unit using thresholds for detecting sounds, an image recording unit that records images captured by the image capturing unit, a moving object detection unit that calculates a difference between an image recorded by the image recording unit and a current image captured by the image capturing unit and detects a location of a moving object from the current image, and a position/sound correspondence information management unit that manages a correspondence between information indicating a specific position in images captured by the image capturing unit and information indicating sounds that could occur at the specific position. The sound detection unit, in the case where a moving object is detected by the moving object detection unit, changes the threshold for detecting a sound managed by the position/sound correspondence information management unit, and detects the specific sound from sounds input by the sound input unit, using the changed threshold, with reference to the correspondence managed by the position/sound correspondence information management unit.

The present invention enables a sound detection apparatus that accurately detects sounds, a control method thereof and a program to be provided.

Further features of the present invention will become apparent from the following description of exemplary embodiments (with reference to the attached drawings).

### BRIEF DESCRIPTION OF THE DRAWINGS

FIG. 1 is a block diagram showing a functional configuration of a sound detection apparatus in an embodiment.

FIG. 2 is a flowchart of moving object detection processing in the embodiment.

FIG. 3 is a flowchart of sound detection processing in the embodiment.

FIG. 4 is a flowchart of a variation of moving object detection processing in the embodiment.

FIG. 5A is a diagram showing exemplary moving object detection and sound detection in the embodiment.

FIG. 5B is a diagram showing exemplary moving object detection and sound detection in the embodiment.

FIG. 5C is a diagram showing exemplary moving object detection and sound detection in the embodiment.

FIG. 6A is a diagram showing a correspondence between positions and sounds in the embodiment.

FIG. 6B is a diagram showing a correspondence between positions and sounds in the embodiment.

FIG. 7A is a diagram showing an exemplary timing of moving object detection and sound detection in the embodiment.

FIG. 7B is a diagram showing an exemplary timing of moving object detection and sound detection in the embodiment.

FIG. 7C is a diagram showing an exemplary timing of moving object detection and sound detection in the embodiment.

FIG. 8A is a diagram showing exemplary sound detection threshold processing in the embodiment.

FIG. 8B is a diagram showing exemplary sound detection threshold processing in the embodiment.

FIG. 8C is a diagram showing exemplary sound detection threshold processing in the embodiment.

FIG. 8D is a diagram showing exemplary sound detection threshold processing in the embodiment.

FIG. 9 is a diagram showing an exemplary correspondence relationship between objects and possible sounds in the embodiment.

FIG. 10 is a flowchart of position/sound correspondence information creation processing in the embodiment.

FIG. 11 is a block diagram showing a functional configuration of the sound detection apparatus in the case of selecting an acoustic model in the embodiment.

FIG. 12 is a flowchart of sound detection processing in the case of selecting an acoustic model in the embodiment.

FIG. 13 is a flowchart of a variation of the sound detection processing in the case of selecting an acoustic model in the embodiment.

FIG. 14 is a diagram showing a correspondence between positions and sounds that includes whether or not a moving object has been detected in the embodiment.

FIGS. 15A and 15B are diagrams showing exemplary sound detection in the case of selecting an acoustic model in the embodiment.

FIG. 16 is a block diagram showing a functional configuration of the sound detection apparatus in the case of learning and selecting background sound models in the embodiment.

FIG. 17 is a flowchart of processing for learning background sound models in the embodiment.

FIG. 18 is a flowchart of processing for learning a general acoustic model.

FIGS. 19A to 19C are diagrams showing exemplary background sound model learning in the embodiment.

FIG. 20 is a diagram showing a correspondence between positions and sounds that includes background sound models in the embodiment.

FIGS. 21A to 21C are diagrams showing exemplary sound detection processing in the case of changing acoustic models and thresholds in the embodiment.

FIG. 22 is a flowchart of position/sound correspondence information creation processing performed by a user operation in the embodiment.

FIGS. 23A to 23D are diagrams showing exemplary position/sound correspondence information creation performed by a user operation in the embodiment.

### DESCRIPTION OF THE EMBODIMENTS

Hereinafter, an embodiment of the present invention is described in detail using the drawings.

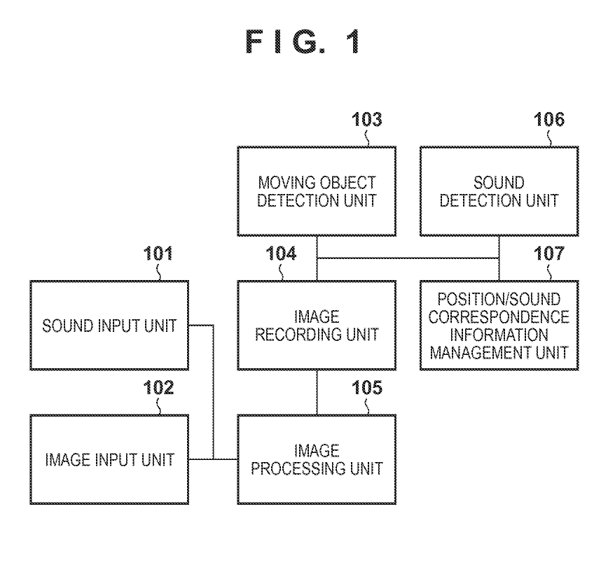

FIG. 1 is a block diagram showing a functional configuration of a sound detection apparatus in the present embodiment.

Reference numeral 101 denotes a sound input unit that captures sounds/voices from a microphone. Reference numeral 102 denotes an image input unit that captures images (still images or moving images) from a camera serving as an image capturing unit. Reference numeral 103 denotes a moving object detection unit that calculates the difference between a past image and a current image, and detects a location (image) where a difference exists in the current image as a location (image) where a moving object exists. Reference numeral 104 denotes an image recording unit that records past images, sounds/voices and the like to recording media (hard disk, memory, etc.). Reference numeral 105 denotes an image processing unit that performs image encoding. Reference numeral 106 denotes a sound detection unit that detects specific sounds. Specifically, sounds to be detected are selected in advance, and an acoustic model is prepared for each type of sound. The similarities between an input sound and the acoustic models are then compared, and the sound of the acoustic model having the highest score is presented as a detection result. Reference numeral 107 denotes a position/sound correspondence information management unit that manages position/sound correspondence information describing the positions of moving objects and the sounds that could occur at those positions.

Note that the sound detection apparatus in FIG. 1 has standard constituent elements (e.g., CPU, RAM, ROM, hard disk, external storage device, network interface, display, keyboard, mouse, etc.) that are installed in a general-purpose computer. These constituent elements realize the various constituent elements in FIG. 1. The various constituent elements may also be realized by software, hardware, or a combination thereof.

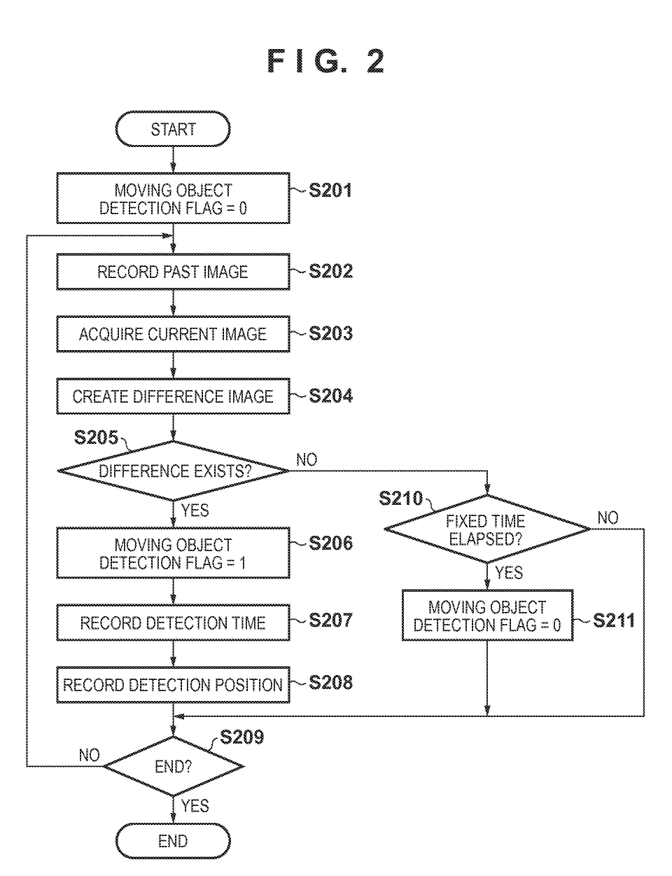

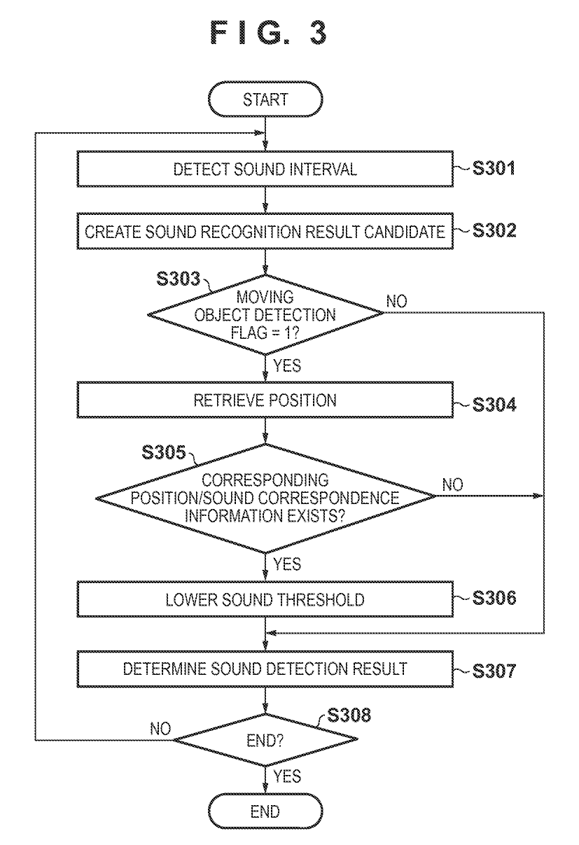

FIG. 2 is a flowchart of moving object detection processing in the present embodiment, and FIG. 3 is a flowchart of sound detection processing in the present embodiment. Moving object detection processing and sound detection processing are independently controlled by the moving object detection unit 103 and the sound detection unit 106, respectively.

Moving object detection involves executing processing for setting a moving object detection flag at the timing at which a moving object is detected, and clearing the moving object detection flag when a predetermined time has elapsed after the moving object is no longer detected. Sound detection involves executing processing for lowering a threshold for detecting a sound corresponding to the position at which the moving object is detected, when the moving object detection flag has been set.

First, the moving object detection processing is described in detail.

At step S201 of FIG. 2, first the moving object detection unit 103 sets the moving object detection flag to 0. At step S202, the moving object detection unit 103 sets an image to serve as the past image, and records the image in the image recording unit 104. At step S203, the moving object detection unit 103 acquires, as the current image, the next frame image after the past image set in step S202 or a frame image after a predetermined time has elapsed. At step S204, the moving object detection unit 103 creates a difference image of the past image and the current image.

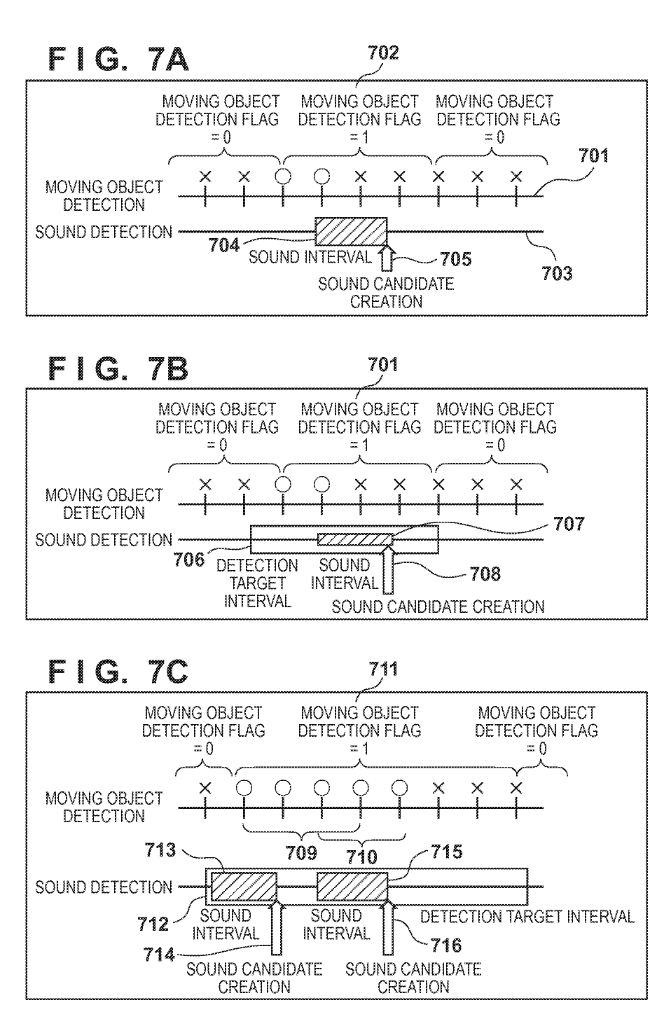

Here, FIG. 7A is a diagram showing the timing at which moving object detection is performed and the timing at which sound detection is performed. Reference numeral 701 denotes a time axis of moving object detection, and reference numeral 703 denotes a time axis of sound detection. In FIG. 7A, the individual scale markings arranged on the time axis 701 show the timing of moving object detection. “◯” above a scale marking denotes that there is a difference, and “x” denotes that there is not a difference.

At step S205, the moving object detection unit 103 determines whether there is a difference. If it is determined that there is a difference (YES at step S205), that is, if it is determined that there is a moving object, the moving object detection unit 103, at step S206, sets the moving object detection flag to 1. At step S207, the moving object detection unit 103 records the detection time. At step S208, the moving object detection unit 103 records the detection position. At step S209, the moving object detection unit 103 determines whether to end the moving object detection. If the case of ending the moving object detection (YES at step S209), the moving object detection unit 103 ends the processing. On the other hand, in the case of not ending the moving object detection (NO at step S209), the moving object detection unit 103 returns to step S202 and repeats the processing.

If it is determined in step S205 that there is not a difference (NO at step S205), the moving object detection unit 103, at step S210, determines whether a predetermined time has elapsed since the moving object detection time, recorded at step S207, at which a moving object was last detected. If it is determined that the predetermined time has elapsed (YES at step S210), the moving object detection unit 103, at step S211, sets the moving object detection flag to 0. The moving object detection unit 103 then proceeds to step S209.

On the other hand, if, in step S210, it is determined that the predetermined time has not elapsed (NO at step S210), the moving object detection unit 103 proceeds to step S209 without performing any processing. This processing is for keeping the moving object detection flag set for a predetermined time even after a moving object is no longer detected. The interval during which the moving object detection flag denoted by reference numeral 702 in FIG. 7A is 1 indicates a state including the predetermined time from when a moving object is no longer detected after having been detected.

Next, the sound detection processing is described in detail.

At step S301 in FIG. 3, the sound detection unit 106 detects a sound interval during which specific sounds could possibly be made, with respect to a sound input by the sound input unit 101. At step S302, the sound detection unit 106 performs sound recognition processing with respect to the detected sound interval to determine which of the assumed specific sounds the input sound approximates, and gives scores to create sound recognition result candidates. Reference numeral 704 in FIG. 7A denotes this sound interval, with sound recognition processing being performed and sound recognition result candidates being created at the timing of an end position 705 of the sound interval 704.

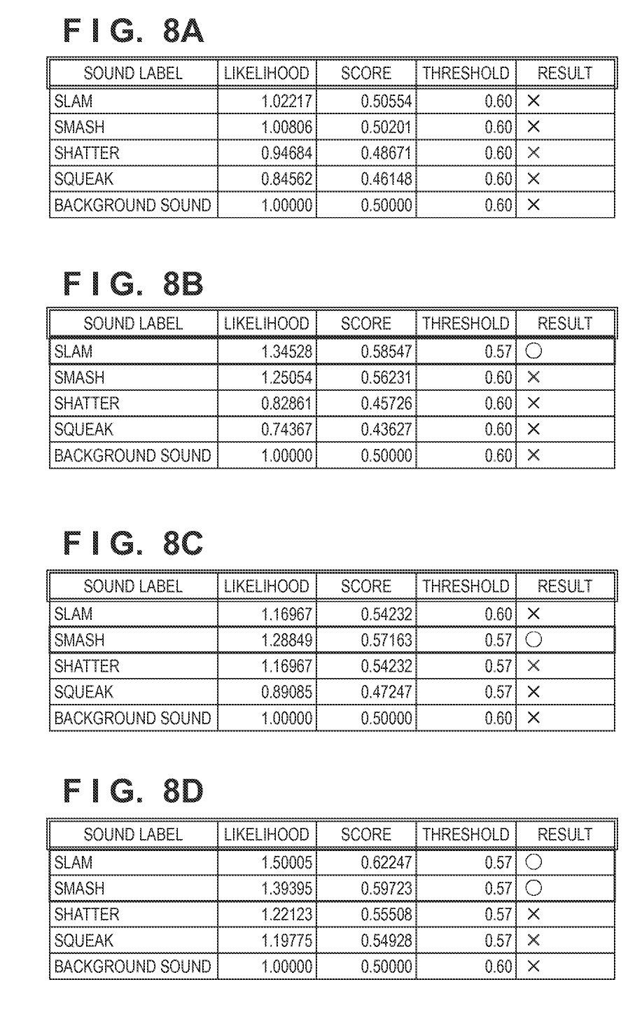

Here, the sound recognition processing is performed by preparing a plurality of models of specific sounds and background sounds, and computing the similarity with feature amounts in the sound interval as a likelihood. The likelihood column in FIGS. 8A to 8D is normalized by dividing the likelihood for individual sound label models by the likelihood for a background sound model. This likelihood is converted to a value not exceeding 1 so that threshold processing can be performed effectively, and the resultant value is taken as a score. This conversion involves computing a score y=(1/(1+exep(−1*(x−1)) with respect to a likelihood x. Note that the normalization processing is not limited to this method. A configuration in which the likelihood of the individual sounds is divided by a total of the likelihoods of all candidates, or in which a score is not converted to a value that does not exceed 1 may be adopted.

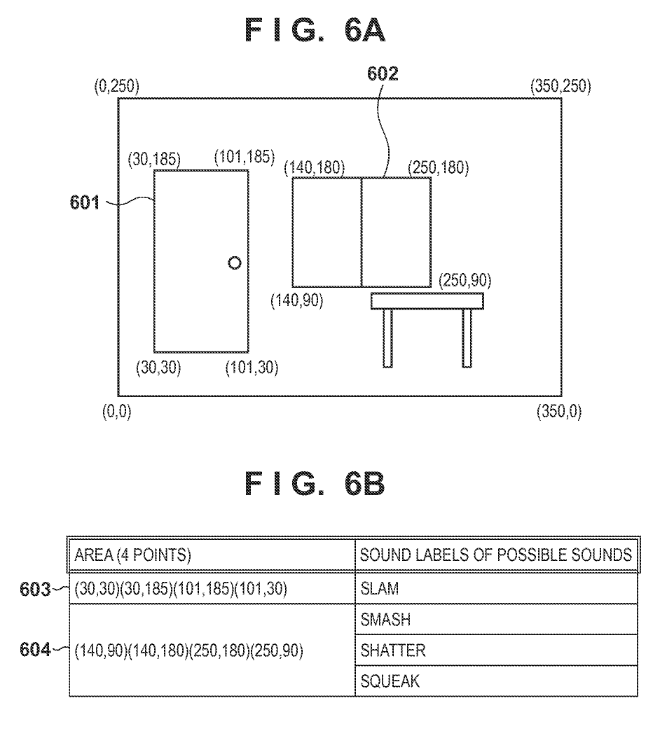

At step S303, the sound detection unit 106 determines whether the moving object detection flag is 1. If it is determined that the moving object detection flag is 1 (YES at step S303), the sound detection unit 106 proceeds to step S304. At step S304, the sound detection unit 106 retrieves a position with reference to a position/sound correspondence information management table (FIG. 6B) managed in a storage medium (memory, etc.), based on the moving object detection time recorded at step S207 and the moving object detection position recorded at step S208. Note that the position/sound correspondence information management table is a table for managing the association of sounds that could possibly occur at the positions (areas) of objects in an image (position/sound correspondence information). At step S305, the sound detection unit 106 determines whether there is position/sound correspondence information corresponding to the retrieved moving object detection position. In the example in FIG. 7A, because the moving object detection flag is 1 at the end position 705, the sound detection unit 106 proceeds to step S304.

In step S305, if it is determined that there is position/sound correspondence information (YES at step S305), the sound detection unit 106, in step S306, lowers the threshold for detecting a sound, with regard to only the sounds of the position/sound correspondence information among the sound recognition result candidates. At step S307, the sound detection unit 106 determines a sound recognition result candidate having a larger score than the threshold as a sound detection result.

On the other hand, if, at step S303, it is determined that the moving object detection flag is 0 (NO at step S303), or if, at step S305, it is determined that there is no position/sound correspondence information corresponding to the moving object detection position (NO at step S305), the sound detection unit 106 proceeds to step S307. In these cases, the sound detection unit 106, at step S307, rather than lowering the thresholds for detecting sounds, determines the sound detection result with the thresholds unchanged similarly to a conventional technique.

After determining the sound detection result at step S307, the sound detection unit 106, in step S308, determines whether to end the sound detection processing. In the case of not ending the sound detection processing (NO at step S308), the sound detection unit 106 returns to step S301 and repeats the processing. On the other hand, in the case of ending the sound detection processing (YES at step S308), the sound detection unit 106 ends the processing.

Hereinafter, specific examples of moving object detection processing and sound detection processing are described.

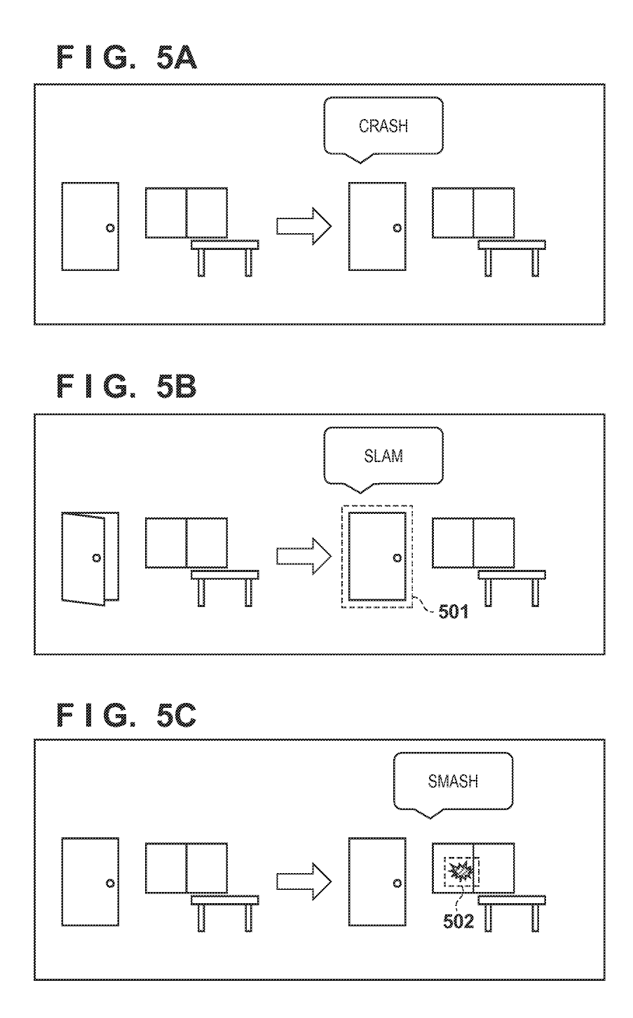

FIG. 5A is a diagram showing an example in which a moving object is not detected in the moving object detection processing. In the sound detection processing, a sound is detected and sound recognition result candidates are created. For example, in the case where a “crash” sound is made, a sound interval is detected, probabilities with respect to assumed specific sounds are computed as likelihoods, and sound recognition result candidates are created. FIG. 8A shows this example. Because the moving object detection flag is not set since no movement has been detected when these candidates are created, the thresholds are still all the same. It is determined, on comparison of the thresholds and the scores, that there is no sound that should to be detected.

FIG. 5B is a diagram showing an example in which a moving object is detected at a position 501 where there is a door. It is determined that a moving object has been detected in the position 501. FIG. 6A is a diagram showing the positions of objects in an image, and FIG. 6B is a diagram showing an example in which the association (position/sound correspondence information) of sounds that could possibly occur at those positions is described as a position/sound correspondence information management table. The numbers in parentheses in FIG. 6A show the coordinates of the objects in the image in units of pixels, in the case where the lower left corner in the diagram is the origin (0, 0). It is checked whether there is an area, among the areas registered in the position/sound correspondence information control table, that overlaps the position 501, which is the moving object detection position in FIG. 5B. In the case where there is an overlapping area, the labels of sounds that could possibly occur in that area are then extracted. The area that overlaps the position 501 is position/sound correspondence information 603 in the position/sound correspondence information control table of FIG. 6B. In this case, given that there is a sound label for the sound “slam”, the threshold of the sound label “slam” in FIG. 8B is lowered, and, as a result, the sound “slam” will be detected.

FIG. 5C is a diagram showing an example in which a moving object is detected at a position 502 where there is a window. It is determined that a moving object has been detected in the position 502. The area overlapping the position 502 is position/sound correspondence information 604 in FIG. 6B. In this case, given that there are sound labels for the sounds “smash”, “shatter” and “squeak”, the thresholds of the sounds “smash”, “shatter” and “squeak” in FIG. 8C are lowered, and the sound “smash” is detected.

Note that although only the correspondence between positions and sounds (sound labels) are described in the position/sound correspondence information managed in the above-mentioned position/sound correspondence information management table, a configuration may be adopted in which the correspondence with reset thresholds is additionally described, and the thresholds are changed per sound label.

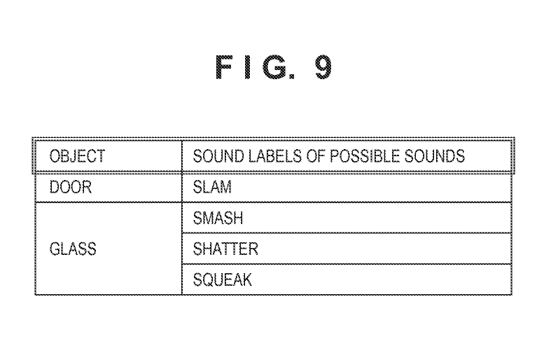

Also, although position/sound correspondence information consisting of preset positions and sounds (sound labels) corresponding thereto is used in the above example, the present invention is not limited thereto. For example, a configuration may be adopted in which object/sound correspondence information consisting of types of objects and types of sounds (sounds that the objects could possibly generate) corresponding thereto is initially created by recognizing objects within an image and positions thereof, and position/sound correspondence information is automatically created using this object/sound correspondence information. FIG. 9 is exemplary object/sound correspondence information, with “door” and “glass” being recognized as objects here, and sounds (sound labels) corresponding to these objects being managed.

Hereinafter, position/sound correspondence information creation processing for creating position/sound correspondence information from object/sound correspondence information is described. This processing is executed through the cooperation of the moving object detection unit 103, the sound detection unit 106, and the position/sound correspondence information management unit 107, for example.

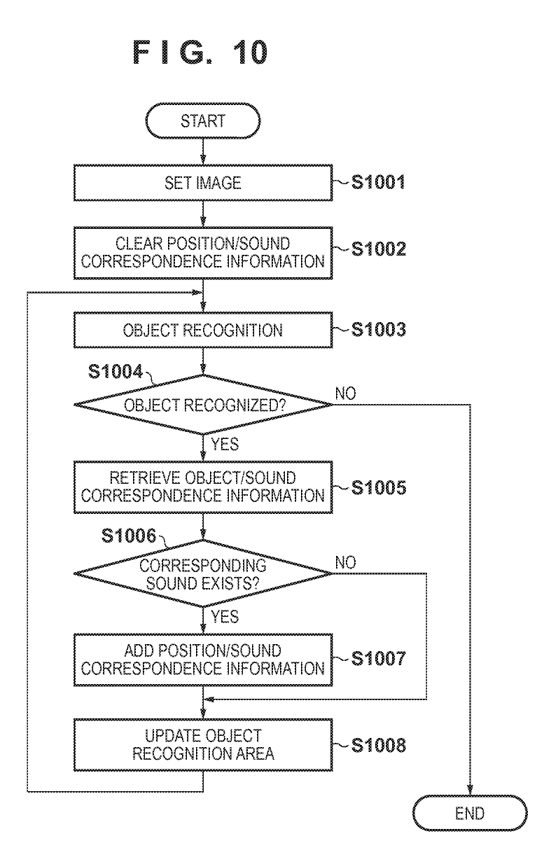

FIG. 10 is a flowchart of the position/sound correspondence information creation processing in the present embodiment. Note that the sound detection processing of FIG. 3 is executed in parallel with this processing, and a specific sound at the time of object detection is detected. Alternatively, the position/sound correspondence information control table may be created by recognizing objects at the time of initial setting, and used at the time of moving object detection.

At step S1001, the position/sound correspondence information management unit 107 sets an image for recognizing objects. At step S1002, the position/sound correspondence information management unit 107 clears the position/sound correspondence information in the position/sound correspondence information management table.

At step S1003, the moving object detection unit 103, as an object recognition unit, recognizes objects in the image. At step S1004, it is determined whether an object has been recognized. If it is determined that there are no recognized objects (NO at step S1004), the processing is ended. On the other hand, if it is determined that there is a recognized object (YES at step S1004), the processing proceeds to step S1005.

At step S1005, the position/sound correspondence information management unit 107 retrieves object/sound correspondence information with reference to an object/sound correspondence information control table for managing objects and sound information corresponding thereto. At step S1006, the position/sound correspondence information management unit 107 determines whether there is a corresponding sound.

If it is determined that there is a corresponding sound (YES at step S1006), the position/sound correspondence information management unit 107, at step S1007, adds the sound corresponding to the detection position of the object as a single record of the position/sound correspondence information management table. In the case where a door is detected as an object at a position 601 in FIG. 6A, the position/sound correspondence information 603 in FIG. 6B is added, and in the case where a window is detected as an object at a position 602 in FIG. 6A, the position/sound correspondence information 604 in FIG. 6B is added.

On the other hand, in step S1006, if it is determined that there are no corresponding sounds (NO at step S1006), the processing proceeds to step S1008.

At step S1008, the position/sound correspondence information management unit 107 updates the areas of the image for recognizing objects. The processing then returns to step S1003, and object recognition is repeated on the next of processing target. In other words, object detection processing is repeated, focusing on an area of the image in which an object has not been detected.

The above processing enables position/sound correspondence information such as shown in FIG. 6B to be created.

Note that although the thresholds for detecting sounds corresponding to the position in which a moving object is detected are lowered in the above example, a configuration may be adopted in which the thresholds are raised. In that case, if a moving object is not detected, the thresholds for detecting all sounds are raised, and if a moving object is detected, the thresholds for detecting all sounds other than sounds corresponding to that position are raised. In this way, the thresholds for detecting sounds are changed (raised/lowered) according to the application, purpose or the like.

Also, although moving object detection processing and sound detection processing are performed independently in the above example, sounds in an interval (timeslot) from immediately before (predetermined time before) a moving object is detected until the present time may be extracted after performing moving object detection, and sound detection processing may be performed retroactively on only those sounds. In this case, a sound recording unit that records sounds input by the sound input unit 101 will be installed in the sound detection apparatus.

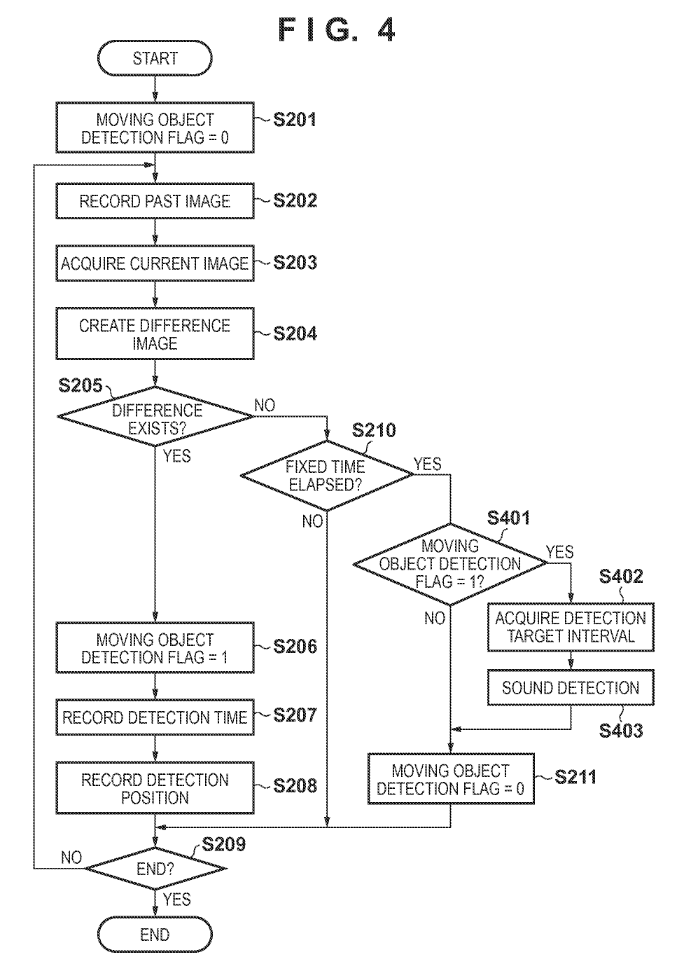

In the case of such a configuration, the moving object detection processing will be as shown in the flowchart of FIG. 4, with FIG. 7B showing an exemplary timing thereof. Note that in the flowchart of FIG. 4, the same step numbers are given to steps that are in common with the flowchart of FIG. 2, and details thereof are omitted.

If, at step S210, it is determined that the predetermined time has elapsed since the moving object detection time was last recorded (YES at step S210), the processing proceeds to step S401. At step S401, the moving object detection unit 103 determines whether the moving object detection flag is 1, that is, whether a moving object was detected before.

If it is determined that the moving object detection flag is 1 (YES at step S401), the processing proceeds to step S402. At step S402, the moving object detection unit 103 acquires a detection target interval to serve as the processing target of the sound detection processing. Specifically, the moving object detection unit 103 acquires a sound interval from the imaging time of a past image immediately before the moving object was detected until the predetermined time has elapsed after the moving object is no longer detected. For example, in FIG. 7B, an interval indicated by reference numeral 706 is acquired as the detection target interval.

Next, at step S403, the sound detection unit 106 performs sound detection processing. This processing is substantially the same as the flowchart of FIG. 3, with the only differences being that the sound target interval for detecting a sound interval at step S302 is restricted, and the end determination method of step S308 changes to a judgment as to whether the detection target interval has ended. Sound detection processing in the situation of FIG. 7B is performed only in the detection target interval 706, and reference numeral 707 denotes a sound interval, within the detection target interval 706, in which a specific sound possibly exists. The sound detection unit 106 then performs sound recognition processing at the timing of an end position 708 of the sound interval 707, and creates sound recognition result candidates. The sound detection unit 106 then lowers the thresholds for detecting sounds corresponding to that position, and determines a sound recognition result candidate having a larger score than its threshold as a sound detection result. Note that the detection target interval 706 may be used as the predetermined time prior to the moving object detection processing immediately preceding the moving object detection processing in which the moving object is detected. Also, a configuration may be adopted in which the moving object detection flag is always set to 1 in the case where detection is performed retroactively.

Also, although processing in the case where a moving object is detected at one location is shown in the above example, similar processing can also be performed in the case where moving objects are simultaneously detected at a plurality of positions. FIG. 7C shows this example. It is assumed that in a moving object detection interval 709 a moving object is detected at the position 602 in FIG. 6A, and that in an interval 710 a moving object is detected at the position 601 in FIG. 6A. Sound detection processing is executed on a detection target interval 712 at the point in time when the moving object flag is set to 0 after an interval 711 during which the moving object detection flag is 1.

When a sound interval 713 is detected and sound recognition result candidates are created at the timing of an end position 714, the detection position in the moving object detection interval 709 is the position 602. Thus, the thresholds for detecting the three sounds “smash”, “shatter” and “squeak” will be lowered, based on the position/sound correspondence information in FIG. 6B.

Also, when a sound interval 715 is detected and sound recognition result candidates are created at the timing of an end position 716, the detection positions in the moving object detection intervals 709 and 710 that overlap the sound intervals are the two positions 602 and 601. Thus, the thresholds for detecting the four sounds “smash”, “shatter”, “squeak” and “slam” will be lowered, based on the position/sound correspondence information in FIG. 6B. FIG. 8D shows this example.

Note that although the image capturing unit for capturing images is an image capturing apparatus (fixed camera) that captures only one point in the above example, the image capturing unit may be an image capturing apparatus having a pan/tilt/zoom function. In that case, an image is captured in capturable directions while panning, tilting and zooming, and a past image is created. The captured image is calibrated so as to enable comparison. An image is then captured in capturable directions while panning, tilting and zooming after a predetermined time, and the difference with the past image is created with the captured image as the current image. A configuration may be adopted in which a sound interval from the point in time when the past image was captured until the point in time when the current image was captured is extracted and sound detection processing is performed, after a moving object has been detected when there is a difference.

Also, the image capturing apparatus may be an omni-directional camera capable of omni-directional imaging. In this case, an omni-directional image is converted into a panorama image, and positions are specified in arbitrary frame units.

Also, although the thresholds for detecting sounds are lowered or raised individually in the above example, a configuration may be adopted in which the thresholds are fixed and the scores are weighted. For example, a configuration may be adopted in which the score of a sound corresponding to the moving object detection position is doubled to achieve substantively the same effect as lowering the threshold.

Also, although threshold processing is performed after computing likelihoods in the sound recognition processing, a configuration may be adopted in which the parameters of a decoder are changed during the sound recognition processing to facilitate detection of sounds corresponding to the moving object detection position.

Also, although the above example is limited to processing up until a sound is detected, a sound output unit may be assigned to the image capturing apparatus, and after detection of a sound, a warning sound notifying that fact may be output. Furthermore, a display unit may be assigned, and after detection of a sound, an image notifying that fact may be output to the display unit.

Also, a configuration may be adopted in which a communication function is assigned to the image capturing apparatus, and after detection of a sound, that fact is notified to the communication destination.

Also, a configuration may be adopted in which a recording unit that records images while indexing the sound detection times and an image playback unit are assigned to the image capturing apparatus to enable cue playback of scenes in which specific sounds are detected.

Also, although sound detection is performed after changing the thresholds of sounds in accordance with the position at which a moving object is detected after performing sound recognition in the above example, the present invention is not limited thereto. For example, a configuration may be adopted in which an acoustic model is selected in accordance with the labels of sounds corresponding to the position in which the moving object was detected to narrow down the types of sounds that are targeted for sound recognition.

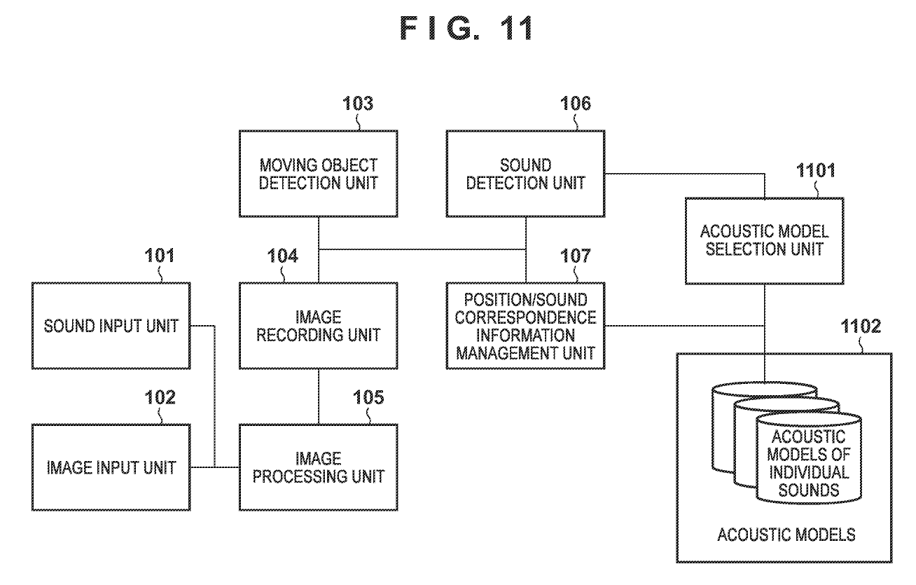

FIG. 11 is a block diagram showing a functional configuration of the sound detection apparatus in the case of selecting an acoustic model.

In FIG. 11, the same reference numerals are given with regard to the same configuration as FIG. 1, and description thereof is omitted. Note that although the sound detection unit 106 of FIG. 1 prepares acoustic models of sounds to serve as detection targets, description of acoustic models is omitted in FIG. 1 because they are not selected individually. Reference numeral 1101 denotes an acoustic model selection unit that selects a suitable acoustic model from among acoustic models 1102 in accordance with the moving object detection position.

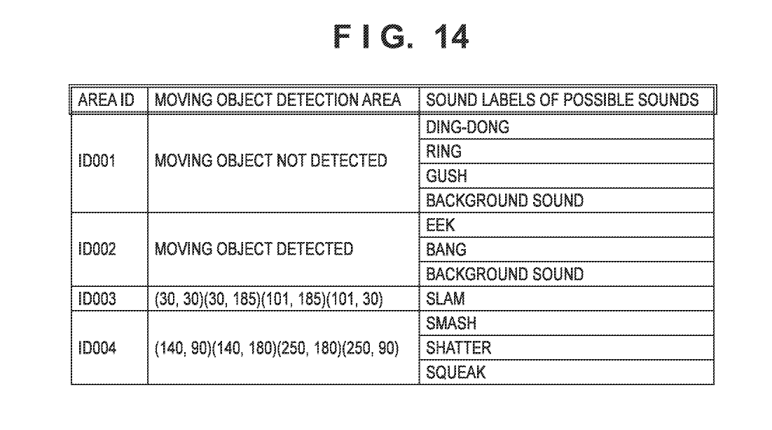

FIG. 14 is a diagram showing a variation of the position/sound correspondence information management table. With the position/sound correspondence information control table shown in FIG. 14, Area ID, Moving Object Detection Area and Sound Labels of Possible Sounds are described.

Moving Object Detection Area is sorted into the case where a moving object is not detected (moving object not detected), the case where a moving object is detected and could be in any position (moving object detected), and the case where a moving object could be detected at a designated position (area designation). In other words, Moving Object Detection Area is sorted into any of information indicating “moving object not detected”, information indicating “moving object detected”, and information indicating coordinates serving as an area designation.

The sounds “ding-dong”, “ring”, “gush” and “background sound” are the sound labels of the acoustic model selected in the case where a moving object is not detected within a captured image. The sounds “eek”, “bang” and “background sound” are the sound labels of the acoustic model selected in the case where a moving object is detected and may be at any position. The sound “slam” is the sound label in the case where a moving object is detected at the position 601 in FIG. 6A, which is the same position as the area designation of the position/sound correspondence information 603 in FIG. 6B. The sounds “smash”, “shatter”, and “squeak” are the sound labels in the case where a moving object is detected in the position 602 of FIG. 6A, which is the same position as the area designation of the position/sound correspondence information 604 in FIG. 6B.

Note that the label “background sound” is the sound label of a background sound model that is used commonly in any of the cases. A background sound model is an acoustic model that is made by compiling sounds that a user wants to exclude from the detection result, and in the case where the score of a background sound model ranks first, there will be no sound detection result. The method of creating a background sound model is discussed later.

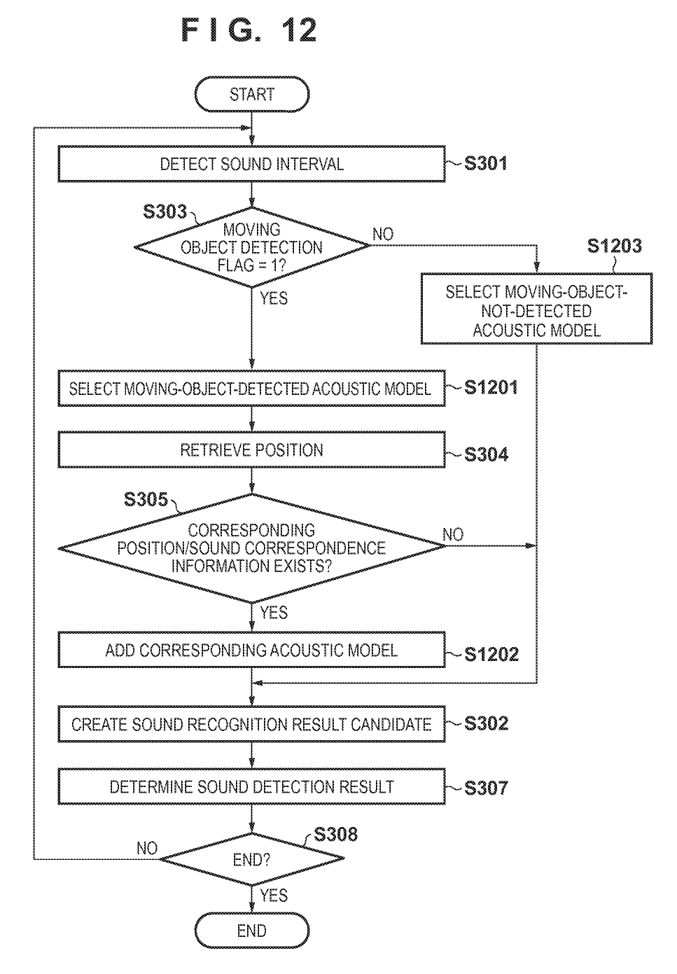

FIG. 12 is a flowchart of the sound detection processing for selecting an acoustic model to be used from among the acoustic models, in accordance with the moving object detection position of the present embodiment.

The differences from the flowchart of the sound detection processing in FIG. 3 are that the determination of the moving object detection flag at step S303 is performed before the sound recognition result candidate creation processing of step S302, and, furthermore, that the acoustic model selection unit 1101 selects an acoustic model before the sound recognition result candidate creation. After the sound interval detection of step S301, the moving object detection flag is determined at step S303. If it is determined that the moving object detection flag is 1 (YES at step S303), the processing proceeds to step S1201, and the acoustic model selection unit 1101 selects the moving-object-detected acoustic model. In the example in FIG. 14, the acoustic model of the sounds “eek”, “bang” and “background sound” will be selected.

Next, if it is determined in step S305 after performing step S304 that there is position/sound correspondence information (YES at step S305), the processing proceeds to step S1202, and the acoustic model selection unit 1101 adds the acoustic model corresponding to sound labels thereof. If a moving object is detected at the position 601 in FIG. 6A, the acoustic model of the sound “slam” is added, and if a moving object is detected at the position 602 in FIG. 6A, the acoustic model of the sounds “smash”, “shatter” and “squeak” is added.

Next, at step S302, the sound detection unit 106 performs sound recognition processing and creates sound recognition result candidates, using the selected acoustic models. At step S307, the sound detection unit 106 determines the sound detection result.

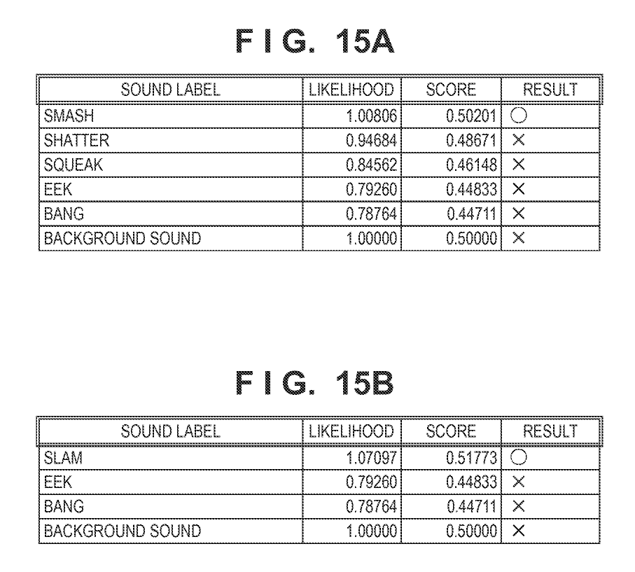

FIG. 15A is a diagram showing sound recognition result candidates and a sound detection result in the case where a moving object is detected at the position 602 in FIG. 6A where there is a window, and a “smash” sound is made. Respective likelihoods are computed for the acoustic models of the sounds “eek”, “bang” and “background sound” for when a moving object is detected at any position, and the sounds “smash”, “shatter” and “squeak” for when a moving object is detected at the position 602 in FIG. 6A, which corresponds to the position/sound correspondence information 604 in FIG. 6B, and the “smash” sound having the highest score is taken as the sound detection result.

FIG. 15B is a diagram showing sound recognition result candidates and a sound detection result in the case where a moving object is detected at the position 601 in FIG. 6A where there is a door, and a “slam” sound is made. Respective likelihoods are computed for the acoustic models of the sounds “eek”, “bang” and “background sound” for when a moving object is detected at any position, and the sound “slam” for when a moving object is detected at the position 601 in FIG. 6A, which corresponds to the position/sound correspondence information 603 in FIG. 6B, and the sound “slam” having the highest score is taken as the sound detection result.

Step S308 is executed after determining the sound detection result at step S307 in the flowchart of FIG. 12.

If, in step S305, it is determined that there is no position/sound correspondence information corresponding to the moving object detection position (NO at step S305), sound recognition result candidates are created at step S302 without adding an acoustic model. In this case, sound recognition is performed with only the acoustic model of the sounds “eek”, “bang” and “background sound” for when a moving object is detected at any position.

If, in step S303, it is determined that the moving object detection flag is 0 (NO at step S303), the processing proceeds to step S1203, and the acoustic model selection unit 1101 selects the moving-object-not-detected acoustic model. In the example of FIG. 14, sound recognition will be performed with the acoustic model of the sounds “ding-dong”, “ring”, “gush” and “background sound”.

In this way, the processing shown in FIG. 12 reduces the possibility of false recognition, by selecting acoustic models to serve as sound recognition candidates in advance depending on the moving object detection position.

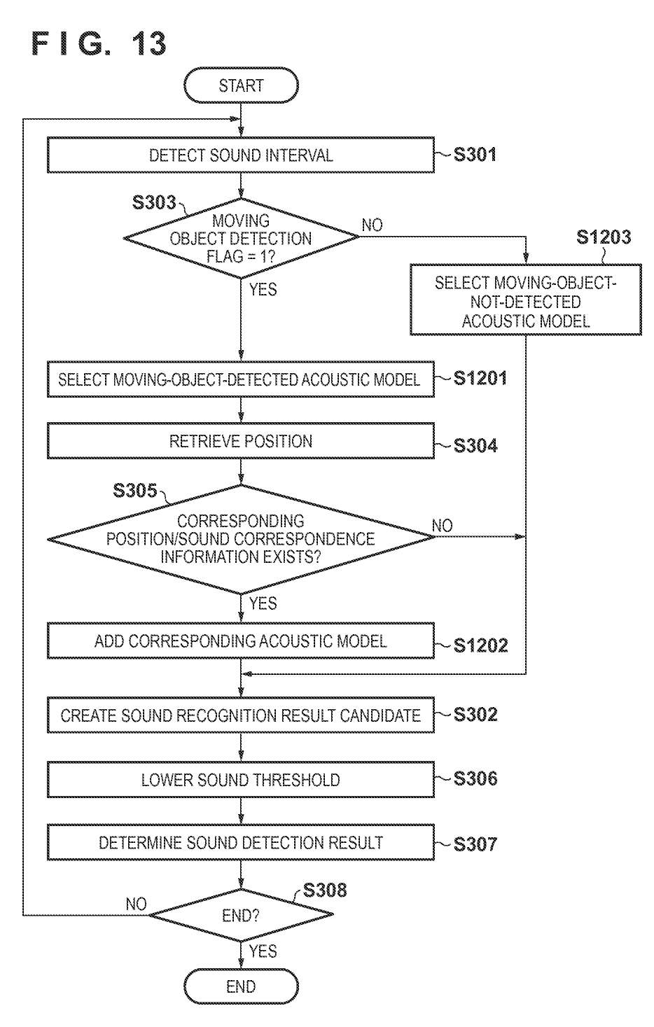

FIG. 13 is a flowchart of sound detection processing that unites the processing of FIG. 3 and the processing of FIG. 12, and involves selecting a suitable acoustic model from among the acoustic models in accordance with the moving object detection position, and changing the thresholds of sounds in accordance with the moving object detection position. Step S306, which is processing for lowering the thresholds of sounds corresponding to the moving object detection position, is inserted between step S302 and step S307 of the flowchart in FIG. 12. Incorporating this step enables the effect of restricting the sound recognition candidates in advance and subsequently raising the priority of sounds that could occur at the moving object detection position to be obtained.

Also, although the types of sounds to serve as sound recognition targets are assumed in advance and acoustic models that can be used are prepared beforehand in the above example, the present invention is not limited thereto. For example, a configuration may be adopted in which background sounds in the usage environment of the sound detection apparatus are recorded in association with moving object detection positions, and background sound models associated with the moving object detection positions are created from the background sounds.

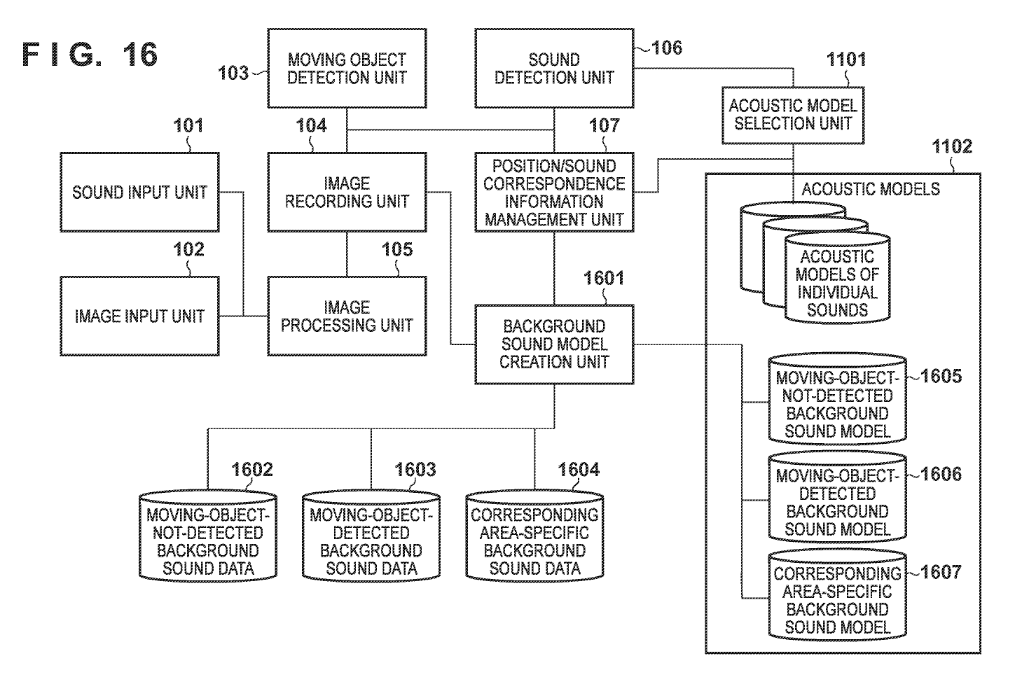

FIG. 16 is a block diagram showing a functional configuration of the sound detection apparatus in the case where background sounds in the usage environment of the sound detection apparatus are recorded in association with moving object detection positions, and background sound models associated with the moving object detection positions are created from the background sounds.

In FIG. 16, the same reference numerals are given with regard to the same configuration as FIG. 11, and description thereof is omitted.

Reference numeral 1601 denotes a background sound model creation unit that, at the time of learning (recording) background sounds, sorts and records background sound data as moving-object-not-detected background sound data 1602, moving-object-detected background sound data 1603 or corresponding area-specific background sound data 1604 in accordance with the state of moving object detection. In other words, the background sound model creation unit 1601 also functions as a background sound recording unit. When learning of background sounds has ended, the background sound model creation unit 1601 creates a moving-object-not-detected background sound model 1605, a moving-object-detected background sound model 1606 and a corresponding area-specific background sound model 1607 from the respective background sounds. Note that the corresponding area-specific background sound model 1607 is created for each specific area of position/sound correspondence information registered in the position/sound correspondence information control table.

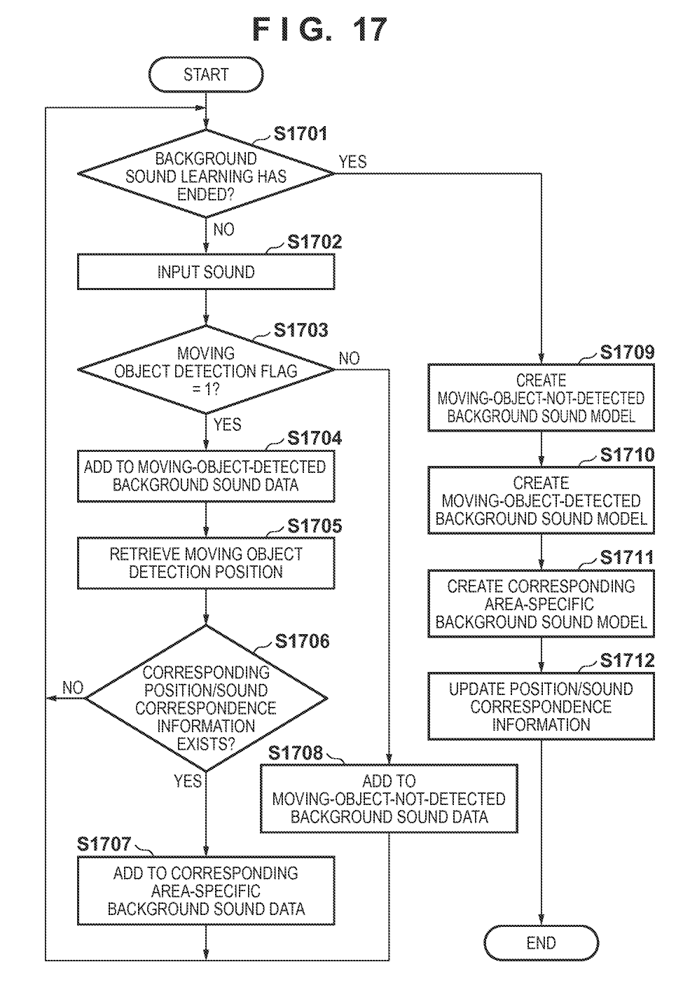

FIG. 17 is a flowchart of processing for creating background sound models associated with moving object detection positions.

At step S1701, it is determined whether learning of background sounds has ended. While learning is ongoing, that is, in the case where learning of background sounds has not ended (NO at step S1701), the processing proceeds to step S1702, and background sound data continues to be recorded. On the other hand, if learning of background sounds has ended (YES at step S1701), the processing proceeds to step S1709, and the processing is ended after creating a series of background sound models.

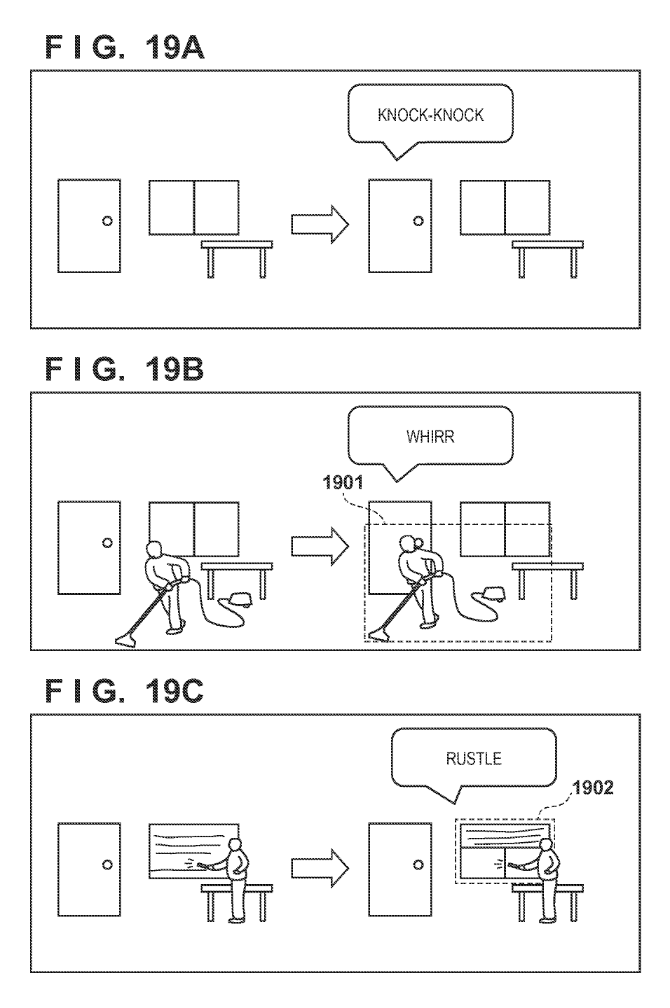

At step S1702, the sound input unit 101 inputs sounds for a predetermined time. Next, at step S1703, the background sound model creation unit 1601 determines whether the moving object detection flag is 1. If it is determined that the moving object detection flag is 0 (NO at step S1703), the processing proceeds to step S1708, and the input sounds are added to the moving-object-not-detected background sound data 1602. The example in FIG. 19A corresponds to this case. A sound coming from outside or the sound of an object that does not result from movement is sorted as a moving-object-not-detected background sound.

On the other hand, if, in step S1703, it is determined that the moving object detection flag is 1 (YES at step S1703), the processing proceeds to step S1704, and the input sounds are added to the moving-object-detected background sound data 1603. The examples in FIG. 19B and FIG. 19C correspond to this case, and the input sounds are sorted as moving-object-detected background sounds regardless of position.

Next, at step S1705, the position/sound correspondence information management unit 107 searches the position/sound correspondence information management table. At step S1706, the position/sound correspondence information management unit 107 determines whether there is position/sound correspondence information corresponding to the moving object detection position. If it is determined that there is position/sound correspondence information (YES at step S1706), the processing proceeds to step S1707, and the background sound model creation unit 1601 adds the sounds corresponding to that area to the corresponding area-specific background sound data 1602. The example in FIG. 19C corresponds to this case, and since the moving object detection position of an area 1902 overlaps a position (position/sound correspondence information 604 in FIG. 6B) registered in the position/sound correspondence information control table, the corresponding sounds are added as background sound data of that area.

On the other hand, if, at step S1701, background sound learning has ended (YES at step S1701), the processing proceeds to step S1709, and the background sound model creation unit 1601 creates a moving-object-not-detected background sound model. Next, at step S1710, the background sound model creation unit 1601 creates a moving-object-detected background sound model. Next, at step S1711, the background sound model creation unit 1601 creates a corresponding area-specific background sound model. Finally, at step S1712, the position/sound correspondence information management unit 107 records the association of these background sound models and positions.

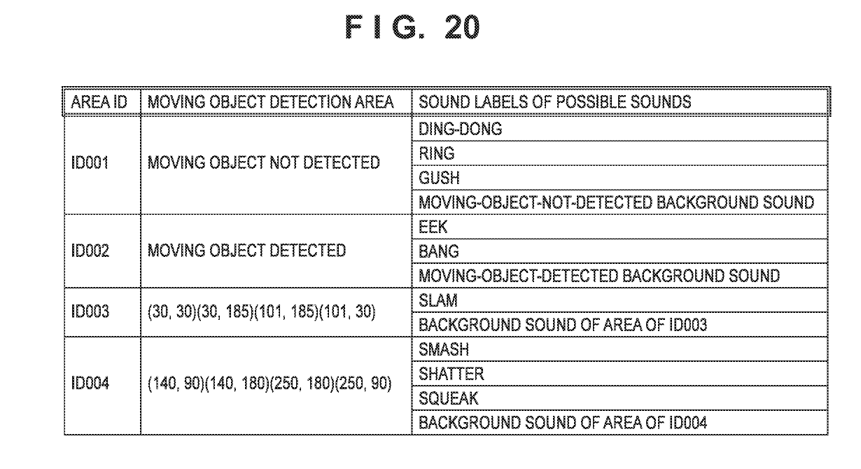

FIG. 20 is a diagram showing a position/sound correspondence information management table also including background sound models. A background sound model is created for each individual area ID. For example, the sound of FIG. 19A is reflected in the moving-object-not-detected background sound model of ID001. The sound of FIG. 19B corresponds to a moving object detected in an area 1901, and this sound is reflected in the moving-object-detected background sound model of ID002. The sound of FIG. 19C corresponds to a moving object detected in the area 1902, and the position of this area 1902 overlaps the position/sound correspondence information 604 in FIG. 6B, or in other words, the position/sound correspondence information of ID004 in FIG. 20. Thus, the sound of FIG. 19C is reflected in the moving-object-detected background sound model of ID002 and the background sound model of ID004.

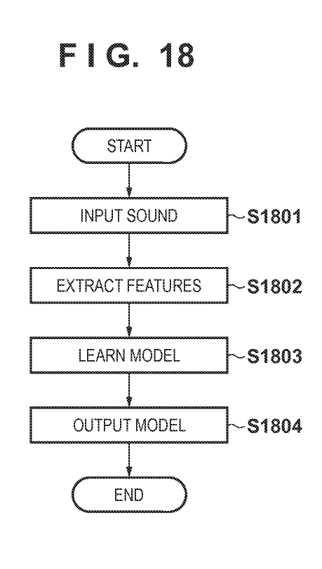

FIG. 18 is a flowchart of the processing for creating a general acoustic model also including a background sound model.

At step S1801, sounds complied for learning are input. At step S1802, feature amounts are extracted from the input sounds. At step S1803, a model is learned. At step S1804, the model is output.

Acoustic models to serve as sound detection targets are created beforehand as specific sounds from sound data collected in advance. Although normal background sound models are often created by collecting noises assumed in advance, there are also background sound models that are recreated by collecting noises on site.

In the present embodiment, sounds (noises) that should not be detected can be effectively selected by sorting background sounds according to the state of moving object detection, and switching background sound models according to the state of moving object detection.

Since sound detection processing in the case of using these background sound models further adds only processing for selecting a background sound model at the time of processing for selecting/adding acoustic models at steps S1201, S1202 and S1203 of FIGS. 12 and 13, description thereof is omitted.

Note that in the above example the moving-object-detected background sound model also includes the sounds for the case where an area is designated. Although the sound in FIG. 19C is sorted into both the moving-object-detected background sound data of ID002 and the specific area background sound data of ID004, a configuration may be adopted in which the moving-object-detected background sound data of ID002 is restricted to background sound data excluding the background sound data of specific areas. In that case, step S1704 of FIG. 17 is performed if the determination result at step S1706 is NO, and step S1201 of FIGS. 12 and 13 is performed if the determination result at step S305 is NO. In this case, the area 1901 in FIG. 19B includes the position of the position/sound correspondence information 603 in FIG. 6B and the position/sound correspondence information 604 in FIG. 6B, as well as other areas. Thus, the area 1901 is recorded in the moving-object-detected background sound data as another area, and the area 1902 in FIG. 19C is recorded as background sound data of the area corresponding to the position of the position/sound correspondence information 604 in FIG. 6B.

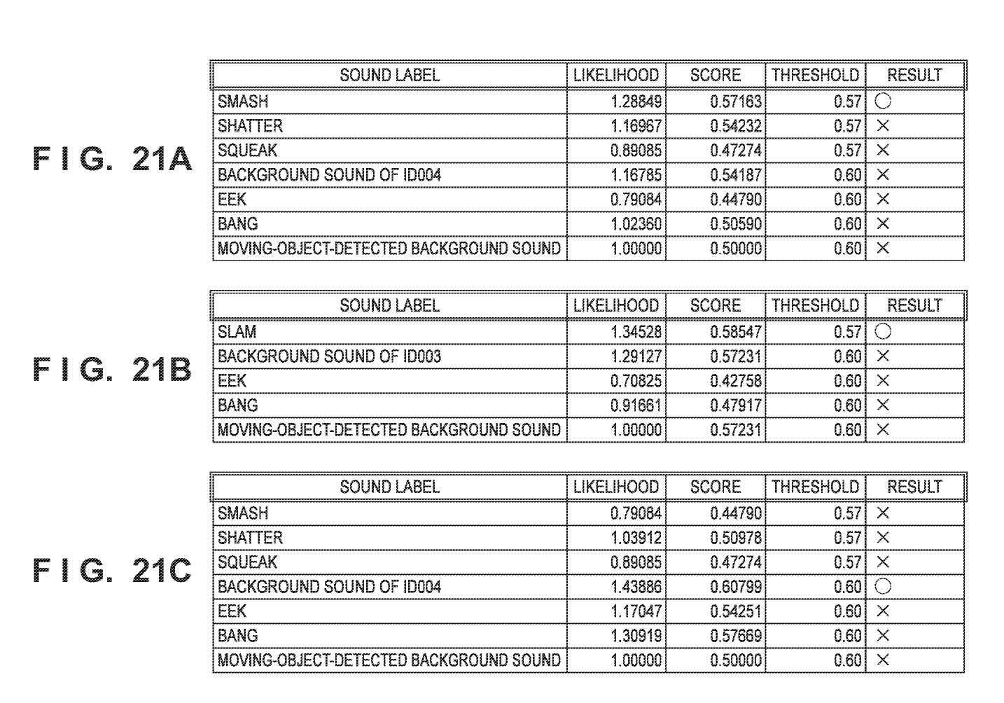

FIGS. 21A to 21C are diagrams showing sound detection results in the case where acoustic models and background sound models are selected according to the moving object detection position, and the thresholds of sounds corresponding to the detection position are lowered.

FIG. 21A is a diagram showing a sound detection result in the case where there is a moving object in the position 602 in FIG. 6A, that is, the area (ID004) of the position/sound correspondence information 604 in FIG. 6B, and there is a “smash” sound. Sound recognition is performed after selecting the sound labels “smash”, “shatter”, “squeak” and the “background sound of ID004” for the case where a moving object is in the specific area (ID004), and the sound labels “eek”, “bang” and “moving-object-detected background sound” for when a moving object is detected, and scores are computed. Also, the thresholds for “smash”, “shatter” and “squeak” for the case where the moving object is in the specific area (ID004) are lowered from 0.60 to 0.57. The sound “smash” having a score exceeding the threshold is thereby selected as the sound detection result. Note that the threshold is not lowered for the “background sound of ID004”. This is because detection of sounds that it is originally desirable to detect may be obstructed when the threshold of the background sound model is lowered, since sounds that it is desirable to detect that could occur in that area are also being learned.

FIG. 21B is a diagram showing a sound detection result for the case where there is a moving object in the position 601 in FIG. 6A, that is, the area (ID003) of the position/sound correspondence information 603 in FIG. 6B, and there is a “slam” sound. Sound recognition is performed after selecting the sound labels “slam” and “background sound of ID003” for the case where a moving object is in the specific area (ID003), and the sound labels “eek”, “bang” and “moving-object-detected background sound” for when a moving object is detected, and scores are computed. Also, the threshold of the sound “slam” in the case where there is a moving object in the specific area (ID003) is lowered from 0.60 to 0.57. The sound “slam” having a score exceeding the threshold is thereby selected as the sound detection result.

FIG. 21C is a diagram showing a sound detection result for the case where there is a moving object in the position 602 of FIG. 6A, that is, the area (ID004) of the position/sound correspondence information 604 in FIG. 6B, and there is a “rustle” sound. Sound recognition is performed after selecting the sound labels “smash”, “shatter”, “squeak” and “background sound of ID004” for the case where there is a moving object in the specific area (ID004) and the sound labels “eek”, “bang” and “moving-object-detected background sound” for when a moving object is detected, and scores are computed. Also, the thresholds for the sounds “smash”, “shatter” and “squeak” for the case where there is a moving object in the specific area (ID004) are lowered from 0.60 to 0.57. The sound label “background sound of ID004” having a score exceeding the threshold is thereby selected as the sound detection result. Since the background sounds of the specific areas are learned from sounds that have actually occurred at those places, there is a greater effect of absorbing sounds that could occur at those locations but are not desirable to be detected than with general background sounds.

Although the position/sound correspondence information control table is automatically created by recognizing objects from the image capturing screen in the above exemplary processing for creating position/sound correspondence information, a configuration may be adopted in which a user creates position/sound correspondence information manually.

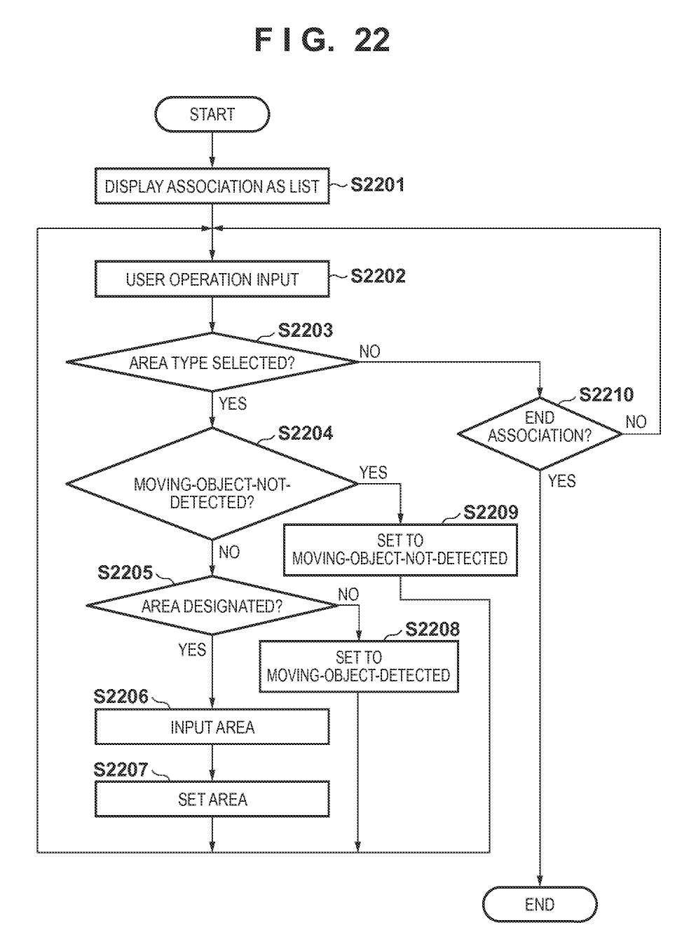

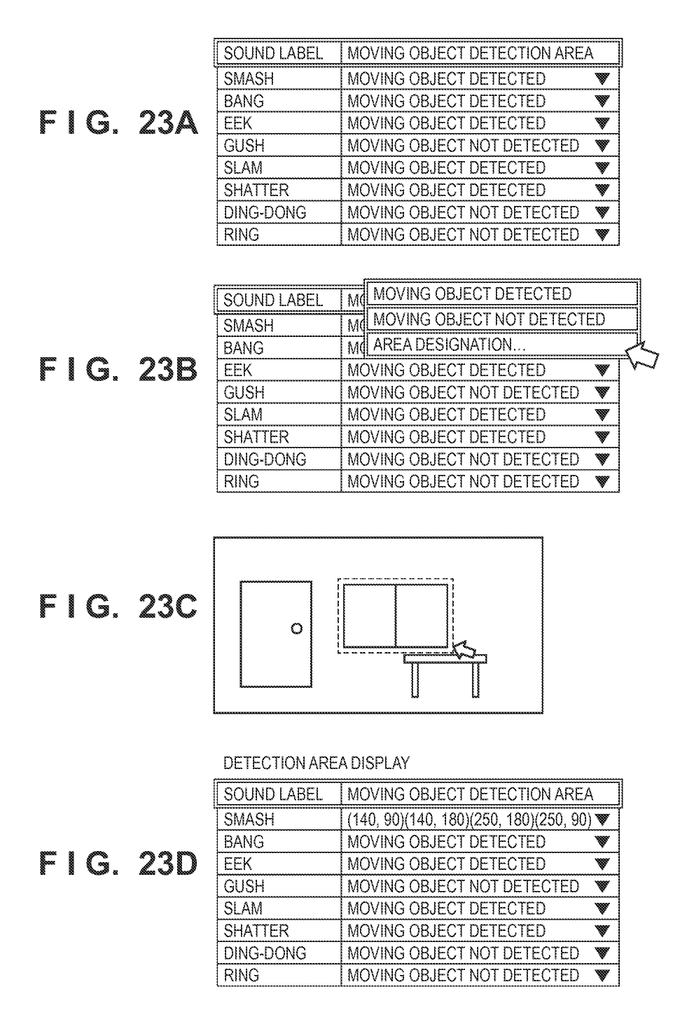

FIG. 22 is a flowchart of processing for creating a position/sound correspondence information management table performed manually by a user, and FIGS. 23A to 23D are diagrams showing exemplary creation screens thereof. Rather than performing this processing directly on a device, a function for setting a network camera via the Web is assumed.

When a user starts creation of position/sound correspondence information, management information of the position/sound correspondence information registered in the position/sound correspondence information management unit 107 is displayed as a list at step S2201. FIG. 23A displays a list of sound labels serving as sound detection targets and detection positions.

Next, at step S2202, the user performs an operation input. When the user selects an item “▾” of the sound label “smash” under “Moving Object Detection Area” in FIG. 23B, “Moving object detected”, “Moving object not detected” and “Area designation . . . ” are displayed in a pop-up menu, and the user selects one of the three items.

At step S2203, it is determined whether the operation is an area type selection, that is, a selection of the item “▾” under “Moving Object Detection Area”. If an area type selection is not made (NO at step S2203), the processing proceeds to step S2210. On the other hand, if an area type selection is made (YES at step S2203), the processing proceeds to step S2204, and it is determined whether “Moving object not detected” was selected. If “Moving object not detected” was selected (YES at step S2204), the processing proceeds to step S2209, and the area designation of the sound label (in this case, “smash”) is set to “Moving object not detected”.

On the other hand, if, in step S2204, “Moving object not detected” was not selected (NO at step S2204), the processing proceeds to step S2205, and it is determined whether “Area designation . . . ” was selected. If “Area designation . . . ” was not selected (NO at step S2205), the processing proceeds to step S2208, and the area designation of the sound label is set as “Moving object detected”.

On the other hand, if “Area designation . . . ” is selected (YES at step S2205), the processing proceeds to step S2206, and an image capturing screen is presented to the user, he or she is prompted to designate a target area with a drag operation, and the designated area is input. FIG. 23C is a diagram showing the area of a window (dashed line area) being selected. Next, at step S2207, association of the designated area is performed, and the position/sound correspondence information management unit 107 updates the contents thereof. FIG. 23D is a diagram showing an exemplary list display reflecting the association thereof.

This processing is repeated until the user performs an operation input that is determined to instruct the end of association at step S2210. In other words, if there is no operation input by the user that is determined to instruct the end of association (NO at step S2210), the processing returns to step S2202, and if there is an operation input by the user that is determined to instruct the end of association (YES at step S2210), the processing is ended.

As described above, according to the present embodiment, images are captured from an image capturing unit together with sounds being input by a sound input unit, and a specific sound is detected from input sounds using captured images. In particular, using the association between a specific position in an image and sounds, a threshold for detecting a sound that could occur at that position is lowered when a moving object is detected, allowing the sound to be detected. In other words, in cases other than when a moving object is detected, false detection of sounds in a scene in which there is no movement can be reduced by keeping the thresholds high and making it unlikely that unwanted sounds will be detected. This also enables false detection of sounds other than sounds that readily occur at a specific position to be reduced in a scene in which there is movement.

Alternatively, by performing detection after raising the thresholds of all sounds in the case where a moving object is not detected, and performing detection after raising the thresholds for detecting all sounds other than sounds that could occur at that position in the case of a moving object is detected, false detection of sounds in a scene in which there is no movement can be reduced. This also enables false detection of sounds other than sounds that readily occur at a specific position to be reduced in a scene in which there is movement.

Alternatively, detection can be facilitated by changing the acoustic model used in sound recognition in a case where a moving object is detected or where a moving object is not detected, and, moreover, by lowering the thresholds of sounds that could occur at the position at which a moving object is detected.

Alternatively, by learning background sound models to be used in sound recognition, and changing the background sound model that is applied, in a case where a moving object is detected or where a moving object is not detected, the possibility of a sound other than a specific sound assumed in advance being falsely recognized as the specific sound can be reduced.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such variations and equivalent structures and functions.

This application claims the benefit of Japanese Patent Application Nos. 2011-119710, filed on May 27, 2011 and 2012-101677, filed Apr. 26, 2012, which are hereby incorporated by reference herein in their entirety.

What is claimed is:

1. A sound detection apparatus that captures images from an image capturing unit together with inputting sounds from a sound input unit, and detects a specific sound from input sounds using captured images, comprising:
a sound detection unit adapted to detect a specific sound from sounds input by the sound input unit, using thresholds for detecting sounds;
an image recording unit adapted to record images captured by the image capturing unit;
a moving object detection unit adapted to calculate a difference between an image recorded by the image recording unit and a current image captured by the image capturing unit, and detect a location of a moving object from the current image; and
a position/sound correspondence information management unit adapted to manage a correspondence between information indicating a specific position in an image captured by the image capturing unit and information indicating sounds that could occur at the specific position,
wherein the sound detection unit, in a case where a moving object is detected by the moving object detection unit, changes the threshold for detecting a sound managed by the position/sound correspondence information management unit, and detects the specific sound from sounds input by the sound input unit, using the changed threshold, with reference to the correspondence managed by the position/sound correspondence information management unit.

2. The sound detection apparatus according to claim 1, wherein the sound detection unit, in a case where a moving object is detected by the moving object detection unit, lowers the threshold for detecting a sound managed by the position/sound correspondence information management unit in association with a position in the image in which the moving object is detected.

3. The sound detection apparatus according to claim 1, wherein the sound detection unit, in a case where a moving object is detected by the moving object detection unit, raises the threshold for detecting sounds managed by the position/sound correspondence information management unit other than a sound associated with a position in the image in which the moving object was detected, and in a case where a moving object is not detected by the moving object detection unit, raises all of the thresholds for detecting sounds managed by the position/sound correspondence information management unit.

4. The sound detection apparatus according to claim 1, further comprising a sound recording unit adapted to record sounds input by the sound input unit,
wherein the sound detection unit, in a case where a moving object is detected by the moving object detection unit, detects the specific sound from sounds recorded by the sound recording unit during a timeslot from a predetermined time before the moving object is detected to a present time.

5. The sound detection apparatus according to claim 1, wherein the position/sound correspondence information management unit further includes an object/sound correspondence information management unit adapted to manage a correspondence between information indicating an object and information indicating sounds that the object could possibly make,
the moving object detection unit further includes an object recognition unit adapted to recognize an object in images captured by the image capturing unit, and
the position/sound correspondence information management unit acquires a sound corresponding to the object recognized by the object recognition unit from the object/sound correspondence information management unit, and newly creates and manages a correspondence between information indicating a position of the object and information indicating the acquired sound.

6. The sound detection apparatus according to claim 1, wherein the image capturing unit has a pan/tilt/zoom function,
the image recording unit records images captured by the image capturing unit in capturable directions using the pan/tilt/zoom function, and
the moving object detection unit, by calculating a difference between an image recorded by the image recording unit and a current image captured by the image capturing unit in capturable directions using the pan/tilt/zoom function after a predetermined time from the recording by the image recording unit, detects a location of a moving object in the current image.

7. The sound detection apparatus according to claim 1, wherein the image capturing unit is an omni-directional camera, and
the moving object detection unit detects a location of a moving object, in arbitrary frame units, in a panorama image obtained from an omni-directional image captured by the omni-directional camera.

8. The sound detection apparatus according to claim 1, wherein the position/sound correspondence information management unit further manages a correspondence between information indicating a case where a moving object is not detected and information indicating sounds that could occur in said case, and a correspondence between information indicating a case where a moving object is detected and information indicating sounds that could occur in said case in any position of the image, and
the sound detection apparatus comprises, as an acoustic model selection unit adapted to select an acoustic model, acoustic model selection unit adapted to:
(1) select, in a case where a moving object is not detected by the moving object detection unit, an acoustic model of the sounds that could occur in the case where a moving object is not detected, and
(2) select, in a case where a moving object is detected by the moving object detection unit, an acoustic model of the sounds that the could occur in the case where a moving object is detected, and
the sound detection unit detects the specific sound from sounds input by the sound input unit, using the acoustic model selected by the acoustic model selection unit.

9. The sound detection apparatus according to claim 8, further comprising:
a background sound recording unit adapted to sort background sounds input by the sound input unit as one of a background sound in the case where a moving object is not detected, a background sound in the case where a moving object is detected, and a background sound in a case where a moving object is detected in an area including the specific position registered in the position/sound correspondence information management unit, and record the sorted background sounds as background sound data, and
a model creation unit adapted to create a moving-object-not-detected background sound model, a moving-object-detected background sound model and an area-specific background sound model from the background sound data sorted and recorded by the background sound recording unit,
the acoustic model selection unit:
(1) selects, in a case where a moving object is not detected by the moving object detection unit, the moving-object-not-detected background sound model, in addition to the acoustic model of the sounds that could occur in the case where a moving object is not detected,
(2) selects, in a case where a moving object is detected by the moving object detection unit, the moving-object-detected background sound model, in addition to the acoustic model of the sounds that could occur in any position in the case where a moving object is detected, and
(3) selects, in a case where a moving object is detected in an area including the specific position by the moving object detection unit, the background sound model of sounds corresponding to the area, in addition to the acoustic model of the sounds corresponding to the area, and
the sound detection unit detects the specific sound from sounds input by the sound input unit, using the acoustic model and the background sound model selected by the acoustic model selection unit.

10. A sound detection apparatus comprising:
a sound input unit adapted to input sounds;
an image input unit adapted to input an image captured by an image capturing unit;
a moving object detection unit adapted to detect a location of a moving object from the image;
a position/sound correspondence information management unit adapted to manage a correspondence between information indicating a specific position in the image and information indicating sounds that could occur at the specific position; and
a sound detection unit adapted to detect a specific sound from sounds input by the sound input unit, using thresholds for detecting sounds,
wherein the sound detection unit, in a case where a moving object is detected by the moving object detection unit, changes the threshold for detecting a sound managed by the position/sound correspondence information management unit.

11. The sound detection apparatus according to claim 10, wherein the sound detection unit, in a case where a moving object is detected by the moving object detection unit, lowers the threshold for detecting a sound managed by the position/sound correspondence information management unit in association with a position in the image in which the moving object is detected.

12. The sound detection apparatus according to claim 10, wherein the sound detection unit, in a case where a moving object is detected by the moving object detection unit, raises the threshold for detecting sounds managed by the position/sound correspondence information management unit other than a sound associated with a position in the image in which the moving object was detected, and in a case where a moving object is not detected by the moving object detection unit, raises all of the thresholds for detecting sounds managed by the position/sound correspondence information management unit.

13. A control method of a sound detection apparatus that captures images from an image capturing unit together with inputting sounds from a sound input unit, and detects a specific sound from input sounds using captured images, comprising:
a sound detection step of detecting a specific sound from sounds input by the sound input unit, using thresholds for detecting sounds;
an image recording step of recording images captured by the image capturing unit to a recording medium;
a moving object detection step of calculating a difference between an image recorded to the recording medium in the image recording step and a current image captured by the image capturing unit, and detecting a location of a moving object from the current image; and
a position/sound correspondence information management step of managing, in a storage medium, a correspondence between information indicating a specific position in images captured by the image capturing unit and information indicating sounds that could occur at the specific position,
wherein the sound detection step, in a case where a moving object is detected in the moving object detection step, comprises changing the threshold for detecting a sound managed in the storage medium in the position/sound correspondence information management step, and detecting the specific sound from sounds input by the sound input unit, using the changed threshold, with reference to the correspondence managed in the storage medium in the position/sound correspondence information management step.

14. A control method of a sound detection apparatus, comprising:
a sound input step of inputting sounds;
an image input step of inputting an image captured by an image capturing unit;
a moving object detection step of detecting a location of a moving object from the image;
a position/sound correspondence information management step of managing, in a storage medium, a correspondence between information indicating a specific position in the image and information indicating sounds that could occur at the specific position; and
a sound detection step of detecting a specific sound from sounds input in the sound input step, using thresholds for detecting sounds,
wherein the sound detection step, in a case where a moving object is detected in the moving object detection step, comprises changing the threshold for detecting a sound managed in the storage medium in the position/sound correspondence information management step.

15. A computer program stored on a non-transitory computer readable medium which causes a computer to control a sound detection apparatus that captures images from an image capturing unit together with inputting sounds from a sound input unit, and detects a specific sound from input sounds using captured images, the program causing the computer to function as:
a sound detection step of detecting a specific sound from sounds input by the sound input unit, using thresholds for detecting sounds;
an image recording step recording images captured by the image capturing unit;
a moving object detection step of calculating a difference between an image recorded in the image recording step and a current image captured by the image capturing unit, and detecting a location of a moving object from the current image; and
a position/sound correspondence information management step of managing a correspondence between information indicating a specific position in images captured by the image capturing unit and information indicating sounds that could occur at the specific position,
wherein the sound detection step, in a case where a moving object is detected in the moving object detection step, changes the threshold for detecting a sound managed in the position/sound correspondence information management step, and detects the specific sound from sounds input by the sound input unit, using the changed threshold, with reference to the correspondence managed in the position/sound correspondence information management step.

16. A computer program stored on a non-transitory computer readable medium which causes a computer to control a sound detection apparatus, the program causing the computer to function as:
a sound input step of inputting sounds;
an image input step of inputting an image captured by an image capturing unit;
a moving object detection step of detecting a location of a moving object from the image;
a position/sound correspondence information management step of managing a correspondence between information indicating a specific position in the image and information indicating sounds that could occur at the specific position; and
a sound detection step of detecting a specific sound from sounds input in the sound input step, using thresholds for detecting sounds,
wherein the sound detection step, in a case where a moving object is detected in the moving object detection step, changes the threshold for detecting a sound managed in the position/sound correspondence information management step.
